(19) United States
(12) Patent Application Publication
(10) Pub. No.: US 2007/0080268 A1
(43) Pub. Date: Apr. 12, 2007

(54) Hawk stand and accessory holder

(76) Inventor: Derek Worrell, Brooklyn, NY (US)

Correspondence Address: Steven Horowitz;Counselor At Law, Suite 700, 295 Madison Avenue, New York, NY, 10017, US

(21) Appl. No.: 11/245,619

(22) Filed: Oct. 7, 2005

(51) Int. Cl. F16M 11/02

(52) U.S. Cl. 248/177.1

(57) ABSTRACT

A hawk stand and holder includes a telescoping vertical rod having a top end and a bottom end, a hawk holder having an aperture for receiving the top end of the vertical rod, a tripod having telescoping legs having a top and intermediate portion, a central ring joining the legs of the tripod at the top portions of the legs and having an aperture for receiving the vertical rod, and a cup element attached to the intermediate portions of the legs to hold the bottom end of the vertical rod. In an embodiment attachable to a ladder, a telescoping first horizontal rod is attached to the bottom end of the vertical rod and clamps to a ladder and a telescoping second rod extends from the first horizontal rod and clamps to the ladder at a second lower rung.

### FIELD OF THE INVENTION

The field of this invention is the construction industry, and more particularly, support structures for holding hawks and other accessories relating to painting used in the construction industry.

### BACKGROUND OF THE INVENTION AND DISCUSSION OF THE PRIOR ART

During indoor construction, it is necessary to cover joined slabs of shee heads, screw heads, etc. with a thick liquid compound. This is done by a construction worker who applies the compound to the wall and/or ceiling. The tool used for directly smearing the compound is typically called a taping knife. The hawk is a flat rectangular board with a handle projecting from the center of the board. The hawk is typically made of aluminum. The procedure used is that an amount of the compound to be applied is taken out of the container with the taping knife and placed on a hawk. The hawk is held by the worker and the taping knife is then used to take the compound from the hawk and repeatedly smear it on the surface of the wall or ceiling. The construction worker is typically standing on a ladder, stilts or scaffolds during part or all of the job.

During the construction process the hawk has to be set aside numerous times and re-grasped. The handle is usually placed between the construction worker's legs. This obviously is not comfortable and causes problems. In some case, the hawk and its holder are often rested on the ledge of the ladder. It often falls off this ledge during construction because the hand of the worker might strike it. Alternatively, the worker rests the hawk on the ceiling, but this is dangerous during construction since it is unsealed and open. Either of these options leads to the hawk falling down to the ground. This is an inconvenience that delays the job.

### SUMMARY OF THE PRESENT INVENTION

A hawk stand and holder includes a telescoping vertical rod having a top end and a bottom end, a hawk holder having an aperture for receiving the top end of the vertical rod, a tripod having telescoping legs having a top and intermediate portion, a central ring joining the legs of the tripod at the top portions of the legs and having an aperture for receiving the vertical rod, and a cup element attached to the intermediate portions of the legs to hold the bottom end of the vertical rod. In an embodiment attachable to a ladder, a telescoping first horizontal rod is attached to the bottom end of the vertical rod and clamps to a ladder and a telescoping second rod extends from the first horizontal rod and clamps to the ladder at a second lower rung.

### IMPORTANT OBJECTS AND ADVANTAGES

The following important objects and advantages of the present invention are:

(1) to provide a hawk stand and holder that allows a construction worker easy access to a hawk;

(2) to provide a hawk stand and holder that saves time during the task of smearing compound on a wall, ceiling, or other area;

(3) to provide a hawk stand and holder that reduces the cost of labor for construction jobs;

(4) to provide a hawk stand and holder that can hold any accessory needed in smearing compound on a surface during construction;

(5) to provide a hawk stand and holder that can securely fasten to a ladder;

(6) to provide a hawk stand and holder that dispenses with the need to find a place to rest the hawk;

(7) to provide a hawk stand and holder that is adaptable to accommodate other holders besides hawk holders, such as paint pan holders, mud pan holders and utility holders;

(8) to provide a hawk stand and holder that is of simple construction;

(9) to provide a hawk stand and holder that includes a tripod;

(10) to provide a hawk stand and holder that in a preferred embodiment can be placed anywhere;

(11) to provide a hawk stand and holder that is composed of parts that can be adjusted in both length and width;

(12) to provide a hawk stand and holder that can telescope both vertically and horizontally;

(13) to provide a hawk stand and holder that can attach securely to many different rungs of a ladder;

(14) to provide a hawk stand and holder that can attach to a step ladder in many different places;

(15) to provide a hawk stand and holder that is designed specifically for hawk and hawk holders;

(16) to provide a hawk stand and holder that can be integrated with a step ladder by easily removably attaching itself whenever desired; and

(17) to provide a construction worker with a convenient way to hold a hawk.

### BRIEF DESCRIPTION OF THE DRAWINGS

FIG. 1 is a perspective view of the first preferred embodiment of the hawk stand and holder of the present invention;

FIG. 2a is a perspective view of the tripod, ring element and cup element of FIG. 1;

FIG. 2b is a side elevation view of the vertical rod used n the hawk stand of the present invention;

FIG. 2c is a perspective view of a hawk;

FIG. 2d is a perspective view of a hawk holder used in the hawk stand and holder of the present invention;

FIG. 3a is a holder used in the hawk stand and holder of the present invention;

FIG. 3b is a paint can holder used as an alternative to the hawk holder of FIG. 3a in the hawk stand and holder of the present invention;

FIG. 3c is a utility holder used as a further alternative to the hawk holder of FIG. 3a in the hawk stand and holder of the present invention;

FIG. 3d is a mud pan holder used as a further alternative holder to the hawk holder of FIG. 3a in the hawk stand and holder of the present invention;

FIG. 4 is a perspective view of the second preferred embodiment of the hawk stand and holder of the present invention shown attached to a ladder;

FIG. 5 is an exploded perspective view of the second preferred embodiment of the hawk stand and holder of the present invention.

### DETAILED DESCRIPTION OF THE PREFERRED EMBODIMENT

The apparatus of the present invention will now be illustrated by reference to the accompanying drawings. The hawk stand and holder of the present invention has been assigned reference numeral 10 Other elements have been assigned the reference numerals referred to below.

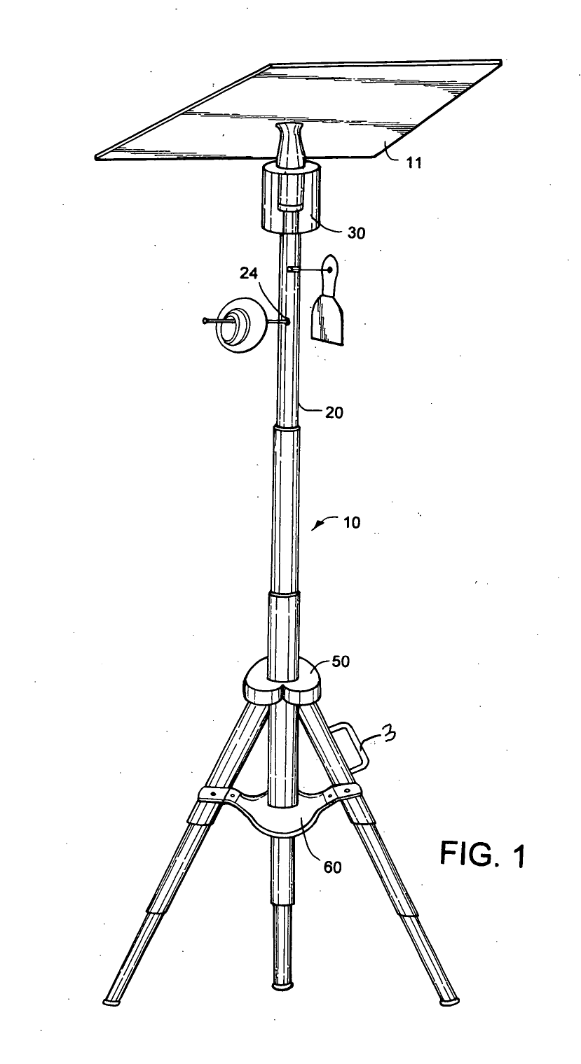

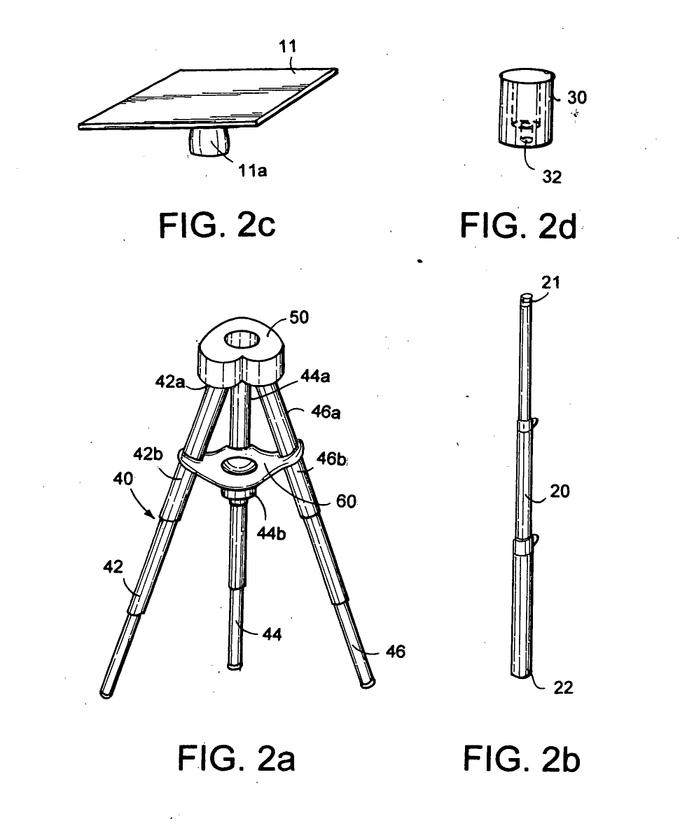

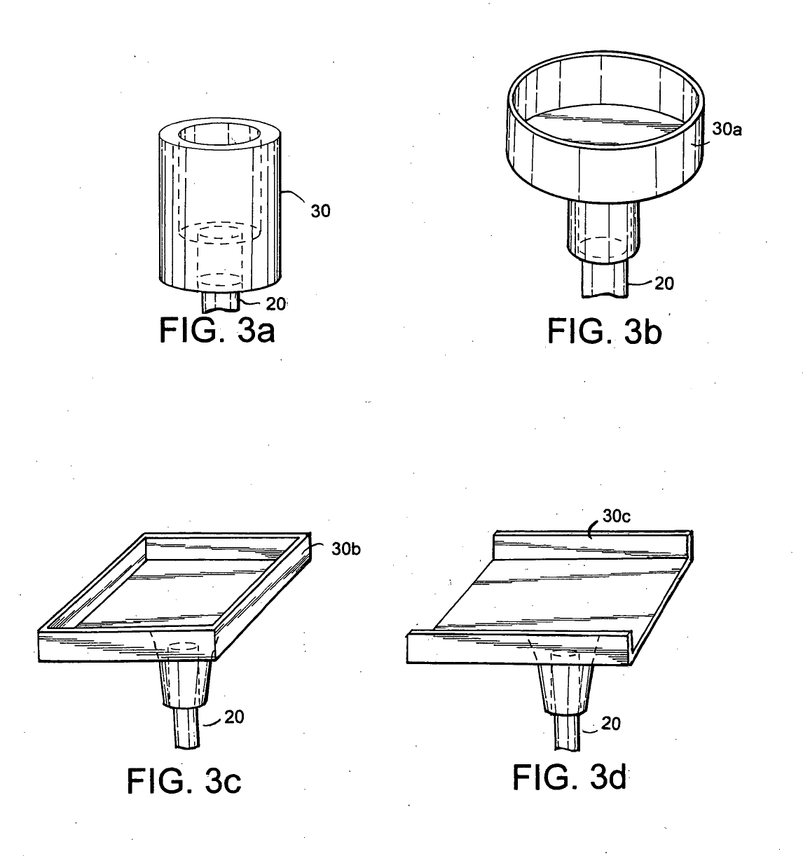

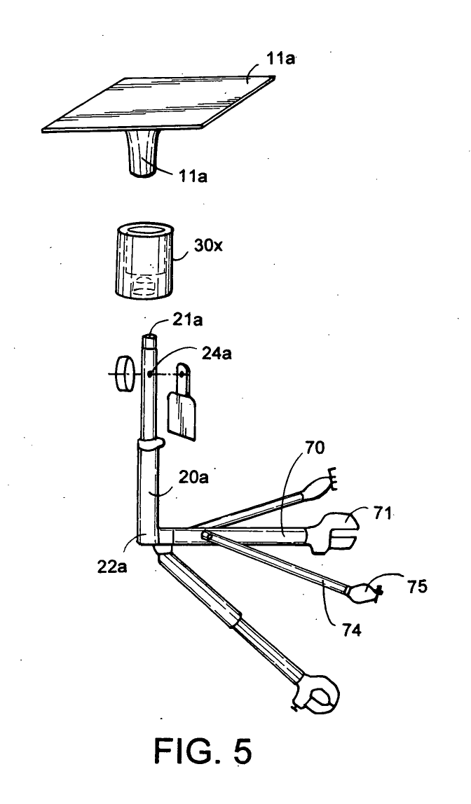

As seen from FIGS. 1-5, two embodiments of a hawk stand and holder 10 is provided. In accordance with a first preferred embodiment, hawk stand and holder 10 include a telescoping vertical rod 20 that has a top end 21 and a bottom end 22. In a preferred embodiment vertical rod 20 can be adjusted at least at two points so that vertical rod 20 is capable of assuming at least three different lengths. In a preferred embodiment, vertical rod 20 also includes in a top portion thereof a hole 24 that can securely receive a peg, the peg used to hang accessories commonly used by the construction worker operating the hawk. Examples of such accessories that often need to be held during the kind of construction work involving the smearing of compound include (i) joint compound tape (a special tape that is applied so that it stays on the wall or ceiling with the compound) and (ii) what is commonly referred to as a “knife” used to perfect the smearing of compound. The accessory is called a knife because it has a flat blade extending from its handle even though the blade need not be sharp and even though the blade of the knife-accessory is much wider proportionally to the blades of conventional knives. As can be seen from FIG. 1, vertical rod 20 tends to taper off in diameter as one goes from its bottom end 22 to its top end 21.

In a preferred embodiment, the vertical rod 20 has a substantially circular cross-section. It is believed that this will make the entire device 10 more stable.

Included in hawk stand and holder 10 is also hawk holder 30 in the form of a can but with an aperture on the bottom of the hawk holder 30. The can is open on the top. As a result of aperture 32 in hawk holder 30, the top end 22 of vertical rod 20 can be inserted into the aperture. The purpose of aperture 32 is so as to allow for receiving the top end of the vertical rod, the hawk holder 30 thereby resting on the vertical rod 20. It is noted that the present invention contemplates that the form of hawk holder is not necessarily in the shape of a can with a hole in its bottom but in any shape capable of holding hawk 11 and accommodating aperture 32 to receive the top end of vertical rod 20. For example, hawk holder 30 can be a generally cylindrical can 30 which has attached to its bottom floor a short cylindrical piece that is narrower than the can and which is open on its distal end and just large enough to receive the top end of the vertical rod. Typically, hawk holder 30 does have at least a generally cylindrical top portion because the handle 1 la of the hawk is cylindrical. If hawk holder is one piece that is cylindrical, then obviously aperture 32 in hawk holder 30 should not be so large that the end of the handle 11a of hawk 11 can fall through said aperture 32.

In an alternative embodiment, hawk holder 30 may be replaced by other holders such as paint can holder 30a (which holds a paint can for use after the compound application process), a utility holder 30b (which holds tools during the compound application process) or a mud pan holder 30c (which holds a mud pan during the compound application process). Each of these holders (30a, 30b, 30c) can receive top end 22 of the vertical rod 20.

Hawk stand and holder 20 also includes tripod 40 which rests on the ground. The tripod 40 comprises a telescoping first leg 42 having a top portion 42a, an intermediate portion 42b and a bottom portion 42c, a telescoping second leg 44 having a top portion 44a, an intermediate portion 44b and a bottom portion 44c telescoping third leg 46 having a top portion 46a, an intermediate portion 46b and a top portion 46c. As can be seen from FIG. 1, one or more of legs 42, 44, 46 of tripod 40 may have a handle 3 projecting from a side thereof in order to facilitate carrying and moving the hawk stand and holder 10 by its tripod 40.

Hawk stand and holder 10 also includes a central ring element 50 joining the first leg 42, the second leg 44 and the third leg 46 at the top portions 42a, 44a, 46a of the first, second and third legs 42, 44, 46. Central ring 50 has a central aperture 51 for receiving the vertical rod 20.

Hawk stand and holder 10 also includes cup element 60 attached to the intermediate portions 42b, 44b, 46b of the first leg 42, second leg 44 and third leg 46. Cup element 60 allows the bottom end 22 of vertical rod 20 to rest thereon without the bottom end 22 of vertical rod 20 necessarily being attached to cup element 60. Cup element 60 in a preferred embodiment includes a concave portion, for example, in the shape of a simple cup. The surrounding portion of cup element 60 is attached to intermediate portions 42b, 44b, 46b of legs 42, 44, 46 of tripod 40 by any suitable means of secure attachment, such as screws, nails, welding, etc. to allow cup element 60.

In a preferred embodiment, cup element 60 is removable to allow legs 42, 44, 46 of tripod 40 to close toward one another (besides telescoping vertically). Alternatively, cup element 60 folds on itself to allow legs 42, 44, 46 top close toward one another.

In some embodiments the hawk 11 may be viewed in combination with the hawk holder and stand 10. The hawk rests in the hawk holder 30.

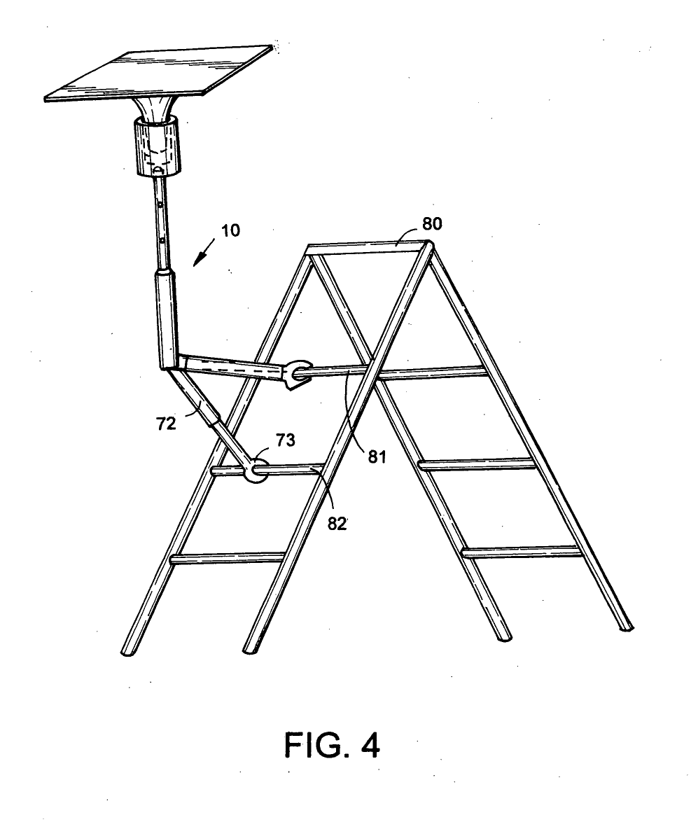

As seen from FIG. 4, there is a second preferred embodiment of the present invention. In this second preferred embodiment, hawk stand and holder 10a comprises a telescoping vertical rod vertical rod 20a that has a top end 21a and a bottom end 22a. As in the first preferred embodiment, vertical rod 20a can be adjusted at least at two points so that vertical rod 20a is capable of assuming at least three different lengths. Vertical rod 20a also includes in a top portion thereof a hole 24a that can securely receive a peg, the peg used to hang accessories commonly used by the construction worker operating the hawk, such joint compound tape and what is commonly called a “knife” by those involved with this kind of construction work. Vertical rod 20a tends to taper off in diameter as one goes from its bottom end 22a to its top end 21a.

Similar to the first embodiment, hawk stand and holder 10a includes hawk holder 30x in the form of a can but with an aperture on the bottom of the hawk holder 30x so that the top end 22a of vertical rod 20a can be inserted into the aperture so as to allow for receiving the top end of the vertical rod, the hawk holder 30x thereby resting on the vertical rod 20a. Once again hawk holder is not necessarily in the shape of a can with a hole in its bottom but in any shape capable of holding hawk 11 and hawk holder 30x may instead be another holder such as paint can holder 30a, utility holder 30b or mud pan holder 30c, each of these holders (30a, 30b, 30c) serving the same purpose as hawk holder 30x, which is to hold an instrument used during the compound application process. The hawk holder 30x has an aperture on a bottom for receiving the top end of the vertical rod, the hawk holder resting on the vertical rod.

Hawk stand and holder 10a is provided with the means to be placed in virtually any position since it is composed of parts that are adjustable both vertically and horizontally. For example, hawk stand and holder 10a also includes a telescoping first horizontal rod 70 attached to the bottom end of the vertical rod 20a and having a first clamp 71 at a distal end of said first horizontal rod 70, the first clamp 71 for attachment of the first horizontal rod 70 to a ladder 80 at a first rung 81. Typically, the first horizontal rod 70 extends so as to make an approximately 90 degree angle with vertical rod 20a.

Hawk stand and holder 10a also includes a telescoping second rod 72 extending from the first horizontal rod 70 and having a second clamp 73 at a distal end of said second rod 72 for attachment of the second rod 72 to the ladder 80 at a second rung 82, the second rung 82 being lower than the first rung 81.

In some preferred embodiments, also included is a telescoping third rod 74 extending from the first horizontal rod 70 and having a third clamp 75 at a distal end of said third rod 74 for attachment of the third rod 74 to the ladder 80 either at the first, second or other rung. Alternatively, third rod 74 extends from the bottom end 22a of vertical rod 20a.

In some embodiments the hawk 1 la may be viewed in combination with the hawk holder and stand 10a. The hawk rests in the hawk holder 30a.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A hawk stand and holder, comprising:
a telescoping vertical rod having a top end and a bottom end, the vertical rod capable of assuming at least three different lengths,
a hawk holder having an aperture on a bottom of the hawk holder for receiving the top end of the vertical rod, the hawk holder resting on the vertical rod,
a tripod resting on a ground, the tripod comprising a telescoping first leg having at least a top portion and an intermediate portion, a telescoping second leg having at least a top portion and an intermediate portion and a telescoping third leg having at least a top portion and an intermediate portion,
a central ring joining the first, second and third legs at the top portions of said first, second and third legs, the central ring having an aperture for receiving the vertical rod,
a cup element attached to the intermediate portions of the first, second and third legs, the cup element for allowing the bottom end of the vertical rod to rest thereon.

2. The hawk stand and holder of claim 1, in combination with a hawk, the hawk resting in the hawk holder.

3. The hawk stand and holder of claim 1, in combination with a hawk, the hawk resting in the hawk holder, and wherein the vertical rod includes in a top portion of said vertical rod a hole that can securely receive a peg used to hang an accessory.

4. The hawk stand and holder of claim 1, wherein the vertical rod includes in a top portion of said vertical rod a hole that can securely receive a peg to hang an accessory.

5. The hawk stand and holder of claim 1, wherein the first leg, the second leg or the third leg has a handle attached thereto.

6. The hawk stand and holder of claim 1, wherein the vertical rod has a substantially circular cross-section.

7. A hawk stand and holder, comprising:
a telescoping vertical rod having a top end and a bottom end,
a hawk holder having an aperture on a bottom of the hawk holder for receiving the top end of the vertical rod, the hawk holder resting on the vertical rod,
a telescoping first horizontal rod attached to the bottom end of the vertical rod and having a first clamp at a distal end of said first horizontal rod, the first clamp for attachment of the first horizontal rod to a ladder at a first rung,
a telescoping second rod extending from the first horizontal rod and having a second clamp at a distal end of said second rod for attachment of the second rod to the ladder at a second rung, the second rung being lower than the first rung.

8. The hawk stand and holder of claim 7, including a telescoping third rod extending from the first horizontal rod and having a third clamp at a distal end of said third rod for attachment of the third rod to the ladder.

9. The hawk stand and holder of claim 7, wherein the first horizontal rod extends substantially perpendicularly from the vertical rod.

10. The hawk stand and holder of claim 7, in combination with a hawk, the hawk resting in the hawk holder.

11. The hawk stand and holder of claim 7, in combination with a hawk, the hawk resting in the hawk holder, and wherein the vertical rod includes in a top portion of said vertical rod a hole that can securely receive a peg used to hang an accessory.

12. The hawk stand and holder of claim 7, wherein the vertical rod includes in a top portion of said vertical rod a hole that can securely receive a peg used to hang an accessory.

13. The hawk stand and holder of claim 12, wherein the peg is to hang joint compound tape.

14. The hawk stand and holder of claim 7, wherein the vertical rod has a substantially circular cross-section.
